(19) United States
(12) Patent Application Publication
(10) Pub. No.: US 2026/0225410 A1
(43) Pub. Date: Aug. 6, 2026

(54) TIRE STRUCTURE AND WHEEL

(71) Applicant: XIAMEN LENCO CO.,LTD., Xiamen (CN)

(72) Inventor: JINQUAN XIE, Xiamen (CN)

(21) Appl. No.: 19/208,506

(22) Filed: May 14, 2025

(30) Foreign Application Priority Data
Feb. 5, 2025 (CN) 202520178482.3

(51) Int. Cl. B60C 19/12

(52) U.S. Cl. CPC B60C 19/12

(57) ABSTRACT

A novel tire structure and a wheel are provided. The structure includes an inner tube, a protective layer, and a tire cover. The protective layer is provided between the inner tube and the tire cover, at least one side of an inner surface of the protective layer is provided with a plurality of reinforcing ribs configured to support the protective layer to reduce its deformation along a length direction. A surface of the inner tube abuts against the reinforcing ribs. The protective piercing layer and TPU film of the present disclosure can play a dual protective role, effectively reducing a risk of air leakage or tire burst caused by sharp objects piercing, ensuring the safety of vehicle driving. The reinforcing ribs provide additional support and improve the protective layer. The structural strength enables it to better withstand external impacts and pressures, reducing its deformation.

### CROSS-REFERENCE TO RELATED APPLICATIONS

This application claims priority to Chinese Patent Application No. 202520178482.3, filed on February 05, 2025, which is hereby incorporated by reference in its entirety.

### TECHNICAL FIELD

The present disclosure relates to the field of tire technologies, and in particular, to a new type of tire structure and a wheel.

### BACKGROUND

As a key component in the vehicle driving system, tires mainly function to support the vehicle body, alleviate the impact force transmitted from a road surface, and generate driving and braking forces through their adhesion to the road surface, thereby ensuring a normal driving of the vehicle. However, in practical use, tires often face a risk of being pierced by sharp objects such as nails, glass, iron slag, etc. Once the tire is punctured, it not only causes air leakage, rendering the vehicle unable to continue driving, but may also lead to serious traffic accidents.

### SUMMARY

The purpose of the present disclosure is to provide a novel tire structure to solve problems raised in the background technology mentioned above.

To achieve the above objectives, the present disclosure provides the following technical solution: a tire structure that can be combined with a wheel rim, where the tire structure includes an inner tube, a protective layer, and a tire cover; the protective layer is provided between the inner tube and the tire cover, and at least one side of an inner surface of the protective layer is provided with a plurality of reinforcing ribs along a length direction; the reinforcing ribs are configured to support the protective layer to reduce its deformation, and a surface of the inner tube abuts against the reinforcing ribs.

In some embodiments of the present disclosure, two sides of the inner surface of the protective layer are both provided with a plurality of reinforcing ribs at equal intervals along the length direction, the reinforcing ribs and the protective layer are integrally formed and are both made of the same material.

In some embodiments of the present disclosure, the protective layer can be made of materials such as polyurethane, thermosetting rubber, thermoplastic rubber, EVA (Ethylene Vinyl Acetate Copolymer), and other plastic materials.

In some embodiments of the present disclosure, an anti-puncture film is provided on an outer surface or the inner surface of the protective layer.

In some embodiments of the present disclosure, the anti-puncture film is provided in a middle of the inner surface of the protective layer, the anti-puncture film abuts against the middle of the surface of the inner tube surface, and the anti-puncture film is a TPU film.

In some embodiments of the present disclosure, the outer surface of the protective layer is provided with a plurality of embosses, and the embosses are formed as an integral structure with the protective layer.

In some embodiments of the present disclosure, a thickness of a middle of the tire cover is greater than that of other parts of the tire cover.

A wheel is further provided, including a wheel rim and the tire structure, where a lower end of the tire cover and a lower end of the protective layer are both wrapped below an inner edge of an outer end of the wheel rim.

In some embodiments of the present disclosure, a valve is provided at a lower of the wheel rim, and an inner end of the valve is communicated to the inner tube.

Compared with existing technology, the beneficial effects of the present disclosure are as follows.

1. The protective puncture layer and TPU film of the present disclosure can provide dual protection, effectively reducing a risk of air leakage or tire blowout caused by sharp objects piercing, ensuring the safety of vehicle driving. Even if the tire is slightly punctured, the anti-puncture layer and TPU film can continue to function, thereby preventing the sharp objects from further damaging the inner tube and avoiding accidents caused by sudden tire blowouts.

2. The present disclosure adds reinforcing ribs on the protective layer, which improves the structural strength of the protective layer and enables it to better withstand external impact and pressure. The reinforcing rib provides additional support, rendering the tire more stable while driving and reducing deformation and displacement of the protective layer. When the inner tube accidentally leaks or bursts, the reinforcing ribs can maintain the shape and performance of the tire, allowing the vehicle to maintain a certain driving ability.

3. The present disclosure has embosses distributed on the outer side of the protective layer and reinforcing ribs provided on the inner side, which can render a connection between the tire cover, the protective layer, and the inner tire tighter and firmer, thereby avoiding slipping or deviation during driving.

### BRIEF DESCRIPTION OF DRAWINGS

FIG. 1 is a front view of the present disclosure.

FIG. 2 is a schematic diagram of an outer side of a protective layer of the present disclosure.

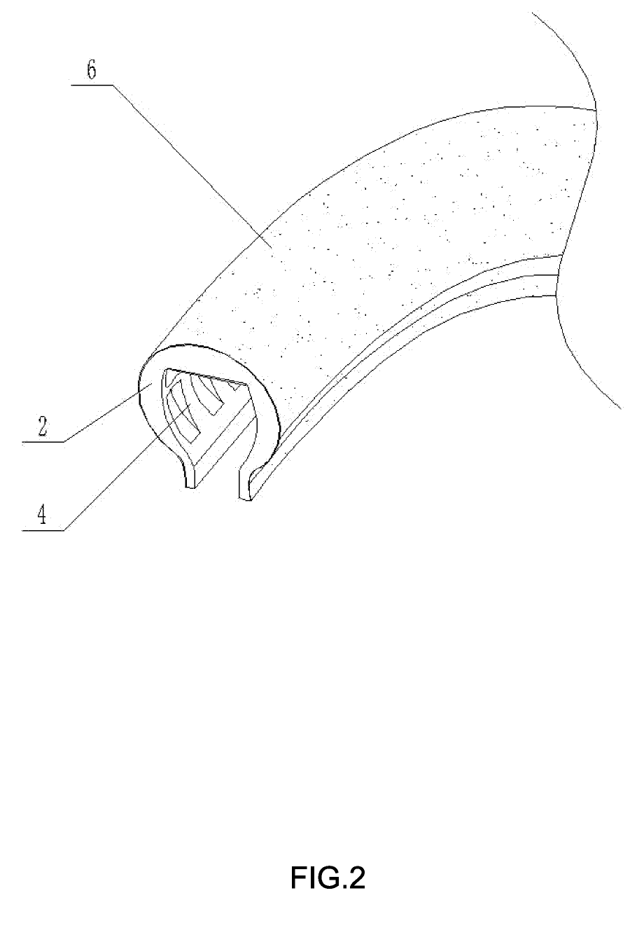

FIG. 3 is a schematic diagram of an inner side of the protective layer of the present disclosure.

Numeral reference: inner tube-1, protective layer-2, tire cover-3, reinforcing rib -4, anti-puncture film-5, emboss -6, and rim-7.

### DESCRIPTION OF EMBODIMENTS

The following will provide a clear and complete description of the technical solution in the embodiments of the present disclosure, based on the accompanying drawings. Obviously, the described embodiments are only a part of the embodiments of the present disclosure, not all of them. Based on the embodiments in the present disclosure, all other embodiments obtained by those skilled in the art without creative work are within the protection scope of the present disclosure.

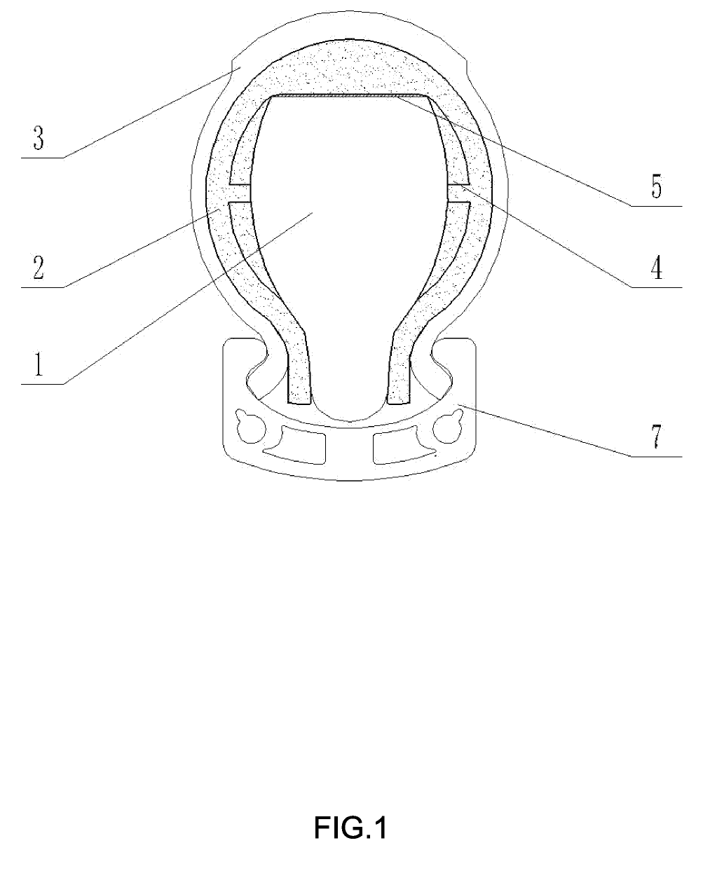

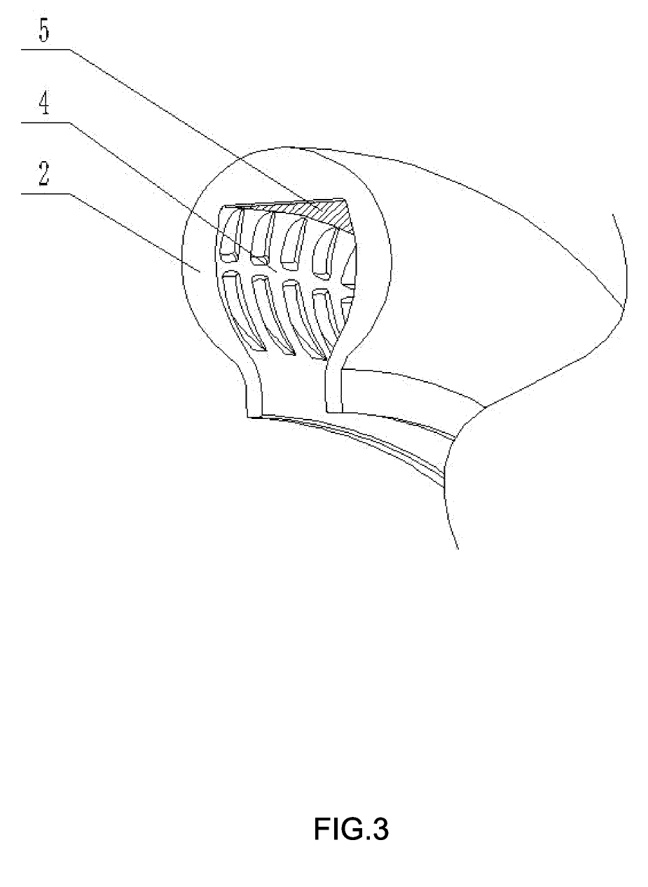

As shown in FIGS. 1 and 3, a new type of tire structure, which can be combined with a wheel rim 7, includes an inner tube 1, a protective layer 2, and a tire cover 3. The protective layer 2 is provided between the inner tube 1 and the tire cover 3, and a plurality of reinforcing ribs 4 are provided at equal intervals along a length direction on two sides of an inner surface of the protective layer 2. The reinforcing ribs 4 and the protective layer 2 are internally formed and both are made of the same material. The reinforcing ribs 4 are configured to support the protective layer 2 to reduce its deformation, and a surface of the inner tube 1 abuts against the reinforcing ribs 4.

The reinforcing ribs 4 can significantly improve a compressive strength of the protective layer 2. When the tire is subjected to external impact or heavy pressure, the reinforcing ribs 4 can disperse and absorb the pressure, thereby preventing the protective layer 2 from deforming and compressing the inner tube 1, causing damage to the inner tube 1. At the same time, due to the reinforcing ribs 4 enhancing a structural strength of the protective layer 2, in case the inner tube 1 is accidentally penetrated or damaged and leaks air, the reinforcing ribs 4 can also effectively support the protective layer 2 and reduce its deformation, thereby allowing the tire cover 3 to maintain its original shape and elasticity for a period of time, rendering it easier for a user to continue moving to the repair site.

The reinforcing ribs 4 can reduce friction and wear between the anti-puncture layer and the inner tube 1. Due to the presence of the reinforcing ribs 4, it can play a limiting and restraining role on the inner tube 1, preventing the inner tube 1 from sliding relative to the protective layer 2 during use. At the same time, the presence of the reinforcing ribs 4 reduces a contact area between the protective layer 2 and the inner tube 1, thereby reducing a friction between the two, which helps to reduce the wear of the inner tube 1 and extend its service life.

At the same time, the reinforcing ribs 4 can serve as an additional barrier. If a sharp object penetrates the anti-puncture layer and pierces the inner tube 1, the spaced reinforcing ribs 4 can act as a limit to the sharp object, preventing it from causing lateral displacement as the tire rolls and preventing further damage to the inner tube 1.

In this embodiment, an anti-puncture film 5 is provided in a middle of the inner surface of the protective layer 2 (by bonding, embedding, etc.), and the anti-puncture film 5 abuts against a middle of the surface of the inner tube 1, and the anti-puncture film 5 is a TPU film. The TPU (thermoplastic urethanes) film has excellent wear resistance and can maintain a smooth surface even after long-term use, rendering it less prone to wear. This enables the tire to better protect the inner tube 1 during driving, avoiding excessive friction between the inner tube 1 and the protective layer 2, which could cause the inner tube 1 to tear.

Besides that, the TPU film has excellent tear resistance, even when subjected to external pulling or sharp object impact, it is not easily torn. On the basis of the protective layer 2, the TPU film serves as a second layer of protection, which can further block the penetration of sharp objects and provide more comprehensive protection. Even if the protective layer 2 is slightly pierced, the TPU film can continue to play a role, preventing tire leakage or damage.

In this embodiment, there are a plurality of embosses 6 distributed on an outer surface of the protective layer 2, and the embosses 6 are integrally formed with the protective layer 2; the embosses 6 can increase a contact area and friction between the protective layer 2 and the tire cover 3, rendering a connection between the two more tighter and firmer.

The embosses 6 can disperse the pressure and impact force subjected by the tire during driving. When the tire comes into contact with the ground, the embosses 6 can evenly distribute pressure between the protective layer 2 and the tire cover 3, reducing local pressure concentration and thus reducing the risk of tire deformation or damage due to excessive pressure.

The presence of the embosses 6 is equivalent to forming an additional protective barrier between the protective layer 2 and the tire cover 3. When a sharp object comes into contact with the tire, the embosses 6 can first block and disperse the impact force of the object, reducing the possibility of the object directly penetrating the tire cover 3 and the protective layer 2.

In this embodiment, a thickness of a middle of the tire cover 3 is greater than that of other parts of the tire cover 3, and a part where the tire contacts the ground is a most severely worn area. Increasing the thickness of this part can significantly improve the wear resistance of the tire. A thicker tread can withstand more friction and wear.

Please refer to FIG. 1. This embodiment further provides a wheel, including a wheel rim 7 and the tire structure described above. A lower end of the tire cover 3 and a lower end of the protective layer 2 are both wrapped under an inner edge of an outer end of the wheel rim 7. A lower of the wheel rim 7 is provided with a valve, and an inner end of the valve is communicated to the inner tube 1; a lower end of the tire cover 3 and a lower end of the protective layer 2 are placed on an inner side of the wheel rim 7, which can prevent the inner tube 1 from getting caught between the tire cover 3 and the protective layer 2 during tire rolling, which could cause the inner tube 1 to tear and result in a tire blowout.

Although the present disclosure has been described in detail with reference to the aforementioned embodiments, it is still possible for those skilled in the art to modify the technical solutions described in the aforementioned embodiments, or to make equivalent substitutions for some of the technical features. Any modifications, equivalent substitutions, improvements, etc. made within the spirit and principles of the present disclosure should be included in the protection scope of the present disclosure.

What is claimed is:

1. A tire structure that can be combined with a wheel rim, wherein the tire structure comprises an inner tube, a protective layer, and a tire cover;
the protective layer is provided between the inner tube and the tire cover, and at least one side of an inner surface of the protective layer is provided with a plurality of reinforcing ribs along a length direction;
the reinforcing ribs are configured to support the protective layer to reduce its deformation, and a surface of the inner tube abuts against the reinforcing ribs.

2. The tire structure according to claim 1, wherein two sides of the inner surface of the protective layer are both provided with a plurality of reinforcing ribs at equal intervals along the length direction,
the reinforcing ribs and the protective layer are integrally formed and are both made of the same material.

3. The tire structure according to claim 1, wherein an anti-puncture film is provided on an outer surface or the inner surface of the protective layer.

4. The tire structure according to claim 3, wherein the anti-puncture film is provided in a middle of the inner surface of the protective layer, the anti-puncture film abuts against the middle of the surface of the inner tube surface, and the anti-puncture film is a TPU film.

5. The tire structure according to claim 1, wherein the outer surface of the protective layer is provided with a plurality of embosses, and the embosses are formed as an integral structure with the protective layer.

6. The tire structure according to claim 1, wherein a thickness of a middle of the tire cover is greater than that of other parts of the tire cover.

7. A wheel, comprising a wheel rim and the tire structure according to claim 1, wherein a lower end of the tire cover and a lower end of the protective layer are both wrapped below an inner edge of an outer end of the wheel rim.

8. The wheel according to claim 7, wherein a valve is provided at a lower of the wheel rim, and an inner end of the valve is communicated to the inner tube.
